(19) United States
(12) Patent Application Publication
(10) Pub. No.: US 2005/0233124 A1
(43) Pub. Date: Oct. 20, 2005

(54) Multilayer acrylic film with improved optical and mechanical properties

(76) Inventors: Gilles Marot, Bernay (FR); David Silagy, Evreux (FR); Gilles Meunier, Mazerolles (FR)

Correspondence Address: Thomas F. Roland, Esq.;Arkema Inc., 2000 Market St., Philadelphia, PA, 19103, US

(21) Appl. No.: 11/009,560

(22) Filed: Dec. 10, 2004

(30) Foreign Application Priority Data
Dec. 12, 2003 (FR) 03.14588

(51) Int. Cl. B32B 7/02

(52) U.S. Cl. 428/216

(57) ABSTRACT

Multilayer acrylic film comprising: a layer (A) made from a thermoplastic acrylic composition comprising from 75 to 95% of a metliacrylic (co)polymer containing mostly methyl methacrylate units and from 5 to 25% of an impact modifier a layer (B) made from either a composition comprising a methacrylic (co)polymer and an impact modifying compound, or a composition prepared by sequential polymerization in aqueous emulsion of acrylate-based monomer systems, or a composition comprising, a block copolymer, and a layer (C) made from a thermoplastic acrylic composition comprising from 75 to 95% of a methacrylic (co)polymer containing mostly methyl methacrylate units and from 5 to 25% of an impact modifier. Use of the film for coating a substrate (thermoplastic resin, thermosetting resin, etc.).

This application claims benefit, under U.S.C. §119(a) of French National Application Number 03.14588, filed Dec. 12, 2003.

### FIELD OF THE INVENTION

The present invention relates to the field of coating of articles made of thermoplastic or thermosetting resins with an acrylic film. It relates more particularly to a multilayer acrylic film that can be used for this purpose, its use in the technique of in-mould decoration, as well as the mouldings coated in this way.

### BACKGROUND OF THE INVENTION

Many articles made of thermoplastic or thermosetting resin (or material) are present in the consumer's everyday life. These resins and plastics such as ABS (acrylonitrile-butadiene-styrene), PVC (polyvinyl chloride), PC (polycarbonate), PP (polypropylene) and their blends, have long been widely used for the manufacture of articles and mouldings, used for example both in the interior and the exterior of motor vehicles, for the manufacture of materials intended for caravans or mobile homes, or incorporated in domestic appliances that are used so widely in the home. They are appreciated notably for their excellent mechanical properties, as well as their ease of large-scale manufacture, resulting in an ever lower price to the consumer.

However, the consumer also wishes to see the technical function of these materials supplemented with improvement in their aesthetic appearance, to combine attractiveness with usefulness. Thus, we may wish to mask the outward appearance of an article in a thermoplastic, such as those mentioned above (generally judged to be poor in aesthetic appearance) with a coating of coloured acrylic resin, with a glossy appearance that is more pleasing to the eye. We may also wish to provide an article made of a thermoplastic material, which is felt to be artificial, with the appearance of a natural and more traditional material, such as wood or leather.

The acrylic resins are thermoplastic polymers that are being used more and more widely on account of their exceptional optical properties. We may mention notably their glossy appearance, their very high transparency with at least 90% transmission of light, their hardness, their thermoforming ability, their resistance to aging, notably under the action of atmospheric agents (more particularly UV radiation), and their ease of shaping.

For these reasons, both technical and aesthetic, we often try to coat articles made of thermoplastics or thermosets with a film of acrylic resin. The latter therefore contributes in particular to protection of the substrate against atmospheric agents, and consequently improves the aging behaviour of the corresponding articles (durability).

The forming techniques suitable for this purpose include notably the technique of decoration during moulding, which is also called “in-mould decoration” in English usage.

According to this technique, an acrylic film, preferably stored in roll form, is preformed in a 1st stage (preceded if necessary by continuous hot bonding to another thermoplastic film or substrate, in a stage called co-lamination) to the required geometry, so as to conform in shape to the inside surface of the mould for forming the desired article. In a 2nd stage, the thermoplastic resin in the molten state is injected into the mould and brought into contact with the film, which has the effect of causing it to adhere to the surface of the article thus formed.

A particularly preferred embodiment of this technique comprises the simultaneous application of the two stages described above, by means of suitable equipment. This embodiment is designated Film Insert Moulding or FIM).

The acrylic films used in this technique can be used as they are, in other words preserving their transparency. They can also be coloured, while preserving their glossy appearance. Finally, using a printing process, they can be provided with a pattern, a design, an image or even characters, text or a logo for conveying certain information to the consumer-. As an example of printing, we may mention the printing of a pattern imitating the appearance of wood or leather.

The patterns or designs printed on the transparent acrylic film can therefore be applied to the surface of the article made of thermoplastic resin, notably by FIM. The film thus printed improves the aging of the article thus coated. Moreover, bearing the printed pattern or design on its surface that is in contact with the substrate, the film also protects the pattern from contact with atmospheric agents, and adds an effect of relief to the pattern that is particularly pleasing to the eye.

U.S. Pat. No. 6,147,162 describes a single-layer acrylic film manufactured from a composition comprising 50-95% of a specific acrylic resin, and 5-50% of a multilayer acrylic polymer, containing an elastomeric layer. Said polymer (also known by a person skilled in the art by the name of impact modifier) is dispersed in the acrylic resin. This film is suitable for the FIM technique, and endows the article so coated with good surface hardness.

Patent EP 1000978 A1 also describes an acrylic film manufactured from a composition comprising 50-95% of a specific acrylic resin, and 5-50% of an impact modifier, suitable for coating by employing the FIM technique, and having an improved surface hardness. In addition this document mentions a laminated film (i.e. a multilayer film), and more precisely a two-layer film, with the inner layer constituted of the composition described above, and the outer layer of an acrylic resin without impact modifier. This two-layer film, described as having excellent surface hardness, can moreover be rolled up as a roll.

U.S. Pat. No. 6,444,298 B1 describes a laminated (or multilayer) acrylic film comprising a layer containing an acrylic resin and particles of acrylic elastomer (corresponding to an impact modifier), called the flexible layer, and a layer containing an acrylic resin without impact modifier, called the surface layer. A system with three layers is also disclosed, in which 2 surface layers are bonded separately to the 2 surfaces of the flexible layer. Said multilayer film makes it possible to improve the colouring treatment (notably by immersion in a bath), by avoiding the whitening and weakening of the colouring of the resin connected with the presence of the impact modifiers. This patent recommends ensuring that the ratio of the thickness of the flexible film to the total thickness of the film is greater than 50%, and preferably greater than 60%.

Application US 2002/0136853 A1 describes a multilayer (two- or three-layer) acrylic film. The three-layer film comprises a flexible film composed of an acrylic resin and particles of acrylic elastomer and two surface layers composed of acrylic resin optionally of particles of acrylic elastomer. It is recommended to ensure that the ratio of the thickness of the flexible layer to the total thickness of the film is greater than 50%, and preferably greater than 80%.

The methods of printing on acrylic film mentioned above further require, within the scope of a highly automated industrial process, passing the film through rotary printing machines where it is submitted to very high tensile stresses. For it to be able to withstand these stresses, it must possess high elongation at break (measured at room temperature), for example above 50%, preferably above 55%.

Passage of the film between the rolls in the printing machines, and its capacity for rolling up as a roll for continuous feed of said machines, also require very high flexibility, corresponding to a tensile elastic modulus (or Young's modulus) between 500 and 1800 MPa, preferably between 700 and 1200 MPa.

However, such a high Young's modulus is often accompanied by excessive flexibility of the film, at the expense of the film's capacity to resist scratching or abrasion, owing to reduced hardness. Scratching is a problem that needs to be avoided, both for aesthetic reasons, and because the substrate is then exposed to atmospheric agents, notably UV radiation, and so is likely to be less durable.

The aim of the present invention is therefore to obtain an acrylic film which, while maintaining its qualities of transparency, also possesses excellent surface hardness giving it improved scratch resistance, and a very high elongation at break (notably enabling it to withstand passage through printing machines), combined with an elastic modulus offering the very high flexibility necessary for storing the film in roll form.

It has now been found that this aim is achieved, fully or partly, by the multilayer acrylic film described hereunder. In the rest of this text, unless stated otherwise, all the percentages shown are to be regarded as percentages by weight.

### SUMMARY OF THE INVENTION

The invention therefore relates to a multilayer acrylic film having a thickness between 40 and 300 μm, preferably between 70 and 100 μm, comprising in this order:
a layer A made from a thermoplastic acrylic composition (A) comprising from 75 to 95% of a methacrylic (co)polymer containing mostly methyl methacrylate units and from 5 to 25% of an impact modifier;
a layer B1 made from a composition (B1) comprising from 10 to 50% of a methacrylic (co)polymer containing mostly methyl methacrylate units and from 50 to 90% of an impact modifying compound;
a layer C made from a thermoplastic acrylic composition (C) comprising from 75 to 95% of a methacrylic (co)polymer containing mostly methyl methacrylate units and from 5 to 25% of an impact modifier;
the layers A, B1 and C being joined together in their respective contact zones.

Preferably, the ratio of the thickness of layer B1 to the total thickness of the multilayer film is between 85 and 99%, preferably between 88 and 95%, and more preferably between 88 and 92%.

According to one variant, the invention relates to a multilayer acrylic film having a thickness between 40 and 300 μm, preferably between 70 and 100 μm, comprising in this order:
a layer A made from a thermoplastic acrylic composition (A) comprising from 75 to 95% of a methacrylic (co)polymer containing mostly methyl methacrylate units and from 5 to 25% of an impact modifier;
a layer B2 made from a composition (B2) that can be obtained by the method comprising:
1) preparation by sequential polymerization in aqueous emulsion:
a) of a first copolymer, by reaction of a system of monomers comprising:
from 75 to 99.8% of at least one acrylate of an alkyl radical comprising from 1 to 8 carbon atoms, and
from 0.1 to 5% of a crosslinking agent selected from the polyacrylic and polymethacrylic esters of polyols, the di- or trivinyl benzenes or the vinyl esters, and
from 0.1 to 20% of at least one grafting agent selected from the allylic, methallylic or crotonic esters of an (α,β-unsaturated monocarboxylic or dicarboxylic acid; then
b) of a second copolymer, in the presence of the aqueous system resulting from stage a), by reaction of a system of monomers comprising:
from 10 to 90% of at least one first acrylate of an alkyl radical containing from 1 to 8 carbon atoms, and
from 9 to 89.9% of at least one second acrylate of an alkyl radical containing from 1 to 8 carbon atoms, different from the first one, and
from 0.1 to 1% of at least one grafting agent selected from the allylic, methallylic or crotonic esters of an α,β-unsaturated monocarboxylic or dicarboxylic acid; then
c) of a third copolymer, in the presence of the aqueous system resulting from stage b), by reaction of a system of monomers comprising:
from 5 to 40% of at least one acrylate of an alkyl radical containing from 1 to 8 carbon atoms, and
from 60 to 95% of at least one second acrylate of an alkyl radical containing from 1 to 8 carbon atoms, different from the first one; then
d) of a fourth polymer, in the presence of the aqueous system resulting from stage c), by reaction of a system of monomers comprising:
from 80 to 100% of at least one acrylate of an alkyl radical containing from 1 to 8 carbon atoms, and
from 0 to 20% ol at least one second acrylate of an alkyl radical containing from 1 to 8 carbon atoms, different from the first one; it being stipulated that:
the weight of the copolymer obtained in stage a) represents from 10 to 75%, and
the total weight of the copolymers introduced in stages b), c) and d) represents from 25 to 90%, relative to the total weight of the composition comprising the 4 copolymers obtained after stage d); then
2) drying of the aqueous emulsion thus obtained; then
3) optionally, granulation of the product thus dried;
optionally a layer C made from a thermoplastic acrylic composition (C) comprising from 75 to 95% of a methacrylic (co)polymer containing mostly methyl methacrylate units and from 5 to 25% of an impact modifier;
the layers A, B2 and optionally C being joined together in their respective contact zones.

Preferably, the ratio of the thickness of layer B2 to the total thickness of the multilayer film is between 85 and 99%, preferably between 88 and 95% and more preferably between 88 and 92%.

According to another variant, the invention relates to a multilayer acrylic film having a thickness between 40 and 300 μm, preferably between 70 and 100 μm, comprising in this order:
a layer A made from a thermoplastic acrylic composition (A) comprising from 75 to 95% of a methacrylic (co)polymer containing mostly methyl methacrylate units and from 5 to 25% of an impact modifier;
a layer B3 made from a composition (B3) comprising from 0 to 5 wt. % of at least one polymer A and from 95 to 100 wt. % of at least one block copolymer of formula B(-A)ₙ composed of a block B and n blocks A obtained by radical polymerization controlled by means of an alkoxyamine of formula I(-T)ₙ in which I denotes a multivalent group, T denotes a nitroxide and n denotes an integer greater than or equal to 2;
optionally a layer C made from a thermoplastic acrylic composition (C) comprising from 75 to 95% of a methacrylic (co)polymer containing mostly methyl methacrylate units and from 5 to 25% of an impact modifier;
layers A, B3 and optionally C being joined together in their respective contact zones.

Preferably, the ratio of the thickness of layer B3 to the total thickness of the multilayer film is between 85 and 99%, preferably between 88 and 95%, and more preferably between 88 and 92%.

Layer C is therefore obligatory when layer B is made from (B1), and optional when layer B is made from (B2) or from (B3).

The multilayer acrylic film that has just been described in its three main variants is, by virtue of the combination of its qualities of surface hardness, elongation at break, and -elastic modulus, particularly suitable for application in the coating of a great variety of articles made of resin, notably by the industrial technique of in-mould decoration. Owing to its high transparency, combined with its advantageous properties of elongation at break, the film is also suitable for the printing of patterns or designs using high-speed industrial printing processes, said patterns being perfectly visible after coating the thermoplastic resin article with the film, thus providing an appreciable aesthetic effect for the consumer, notably an attractive relief effect. The film according to the invention can therefore be rolled up as a reel and then used in rotary printing machines. Furthermore, it has very good scratch resistance and good transparency.

Preferably, the ratio of the thickness of layer B1 (or B2 or B3) relative to the total thickness is between 85 and 99%, preferably between 88 and 95%, and more preferably between 88 and 92%, so as to endow the multilayer acrylic film with sufficient flexibility while maintaining high elongation at break.

### DETAILED DESCRIPTION OF THE INVENTION

Regarding the methacrylic (co)polymer of layers A and optionally C, as well as for composition (B1) of layer B, the latter comprises mostly methyl methacrylate units. This methacrylic (co)polymer thus defined is also designated by the term “acrylic matrix”. It comprises from 51 to 100% of methyl methacrylate units and from 0 to 49% of ethylenically unsaturated comonomer units copolymerizable with methyl methacrylate.

The ethylenically unsaturated monomers copolymerizable with methyl methacrylate are notably selected from:
the acrylic monomers of formula CH₂═CH—C(═O)—O—R₁ where R₁ denotes a hydrogen atom, a linear, cyclic or branched C₁-C₄₀ alkyl group optionally substituted by a halogen atom, a hydroxy, alkoxy, cyano, amino or epoxy group. It may be, for example, acrylic acid, methyl, ethyl, propyl, n-butyl, isobutyl, tert-butyl, 2-ethylhexyl, or glycidyl acrylate, hydroxyalkyl acrylates, acrylonitrile;
the methacrylic monomers of formula CH₂═C(CH₃)—C(═O)—O—R₂ where R₂ denotes a hydrogen atom, a linear, cyclic or branched C₁-C₄₀ alkyl group optionally substituted by a halogen atom, a hydroxy, alkoxy, cyano, amino or epoxy group. It may be, for example, methacrylic acid, methyl, ethyl, propyl, n-butyl, isobutyl, tert-butyl, 2-ethylhexyl, or glycidyl methacrylate, hydroxyalkyl methacrylates, methacrylonitrile:
the vinylaromatic monomers. It may be for example styrene, or substituted styrenes such as alpha-methylstyrene, monochlorostyrene, tert-butyl styrene.

The acrylic matrix used for making the layers of the film according to the invention is generally obtained in the form of beads or granules. Beads are obtained by the well-known method of polymerization in aqueous suspension of the monomer or monomers, in the presence of an initiator that is soluble in the monomer or monomers, and a suspending agent. Granules can be obtained from the beads, which are melted in an extruder to form rods, which are then cut up. Granules can also be prepared by bulk polymerization, a well-known method, comprising polymerizing the monomer or monomers or a syrup of prepolymer dissolved in the monomer or monomers, in the presence of an initiator and a chain transfer agent for controlling the molecular weight of the polymer. The polymer obtained is forced at the end of the line through a die to produce rods, which are then cut into granules.

Layer A, layer B1 made from composition (B1), and, if applicable, layer C of the multilayer film according to the invention, are prepared starting from the acrylic matrix as described above, it being understood that the nature of said matrix can be identical or different for the respective layers of one and the same multilayer film according to the invention. It is preferable, however, for reasons of industrial logistics, to use the same acrylic matrix for layers A and C. Layer C is optional when using a layer B2 or a layer B3.

It is preferable to use, as acrylic matrix for manufacture of composition (B1) of layer B1, and/or for manufacture of layer A and/or C, a copolymer comprising from 80 to 99 wt. % of methyl methacrylate units, and from 1 to 20% of (meth)acrylic acid or the corresponding ester with an alkyl radical containing from 1 to 4 carbon atoms. According to a more particularly preferred variant, the comonomer combined with the methyl methacrylate unit is acrylic acid, methyl acrylate or ethyl acrylate. Advantageously, it is ethyl acrylate.

Layers A, and optionally C, also contain, apart from the methacrylic (co)polymer, an impact modifier at the rate of 75 to 95% of the meth-acrylic (co)polymer per 5 to 25% of the impact modifier.

Regarding the impact modifier that can be used for compositions (A), (B1) and optionally (C), it has a structure with several layers, at least one of which is constituted of an elastomeric phase. Since it is the elastomeric phase contained in the modifier that imparts the impact resistance, this additive is added to the acrylic matrix to give a suitable proportion of the elastomer.

The impact modifier used in the invention can be made up of a block copolymer comprising at least one elastomer block resulting from the polymerization of monomers such as butadiene, substituted or unsubstituted, alkyl or aralkyl acrylates. In particular it can be a two-block copolymer, such as poly(butadiene-block-methyl methacrylate) or a three-block copolymer such as poly(styrene-block-butadiene-block-methyl methacrylate) in which the polybutadiene elastomer phase represents up to about 50 wt. % of the mass of the block copolymer. The butadiene block can be unhydrogenated, partially or fully hydrogenated. It can also be a poly(methyl methacrylate-block-butyl acrylate-block-methyl methacrylate), copolyetheresteramides with polyamide and polyether sequences, and copolymers with polyester and polyether sequences.

The impact modifier can also be a polymeric substance having a structure with several layers, at least one of which is an elastomer phase. These polymeric substances can thus be particles obtained by coagulation or by drying (notably by spraying or atomization) of an elastomer latex. The manufacture of said latices, used for impact reinforcement of thermoplastic matrices, is familiar to a person skilled in the art. In particular it is known that by varying the conditions of manufacture of these latices, it is possible to influence their morphology and consequently their ability to improve the impact resistance and their ability to maintain the optical properties of the acrylic matrix that is to be reinforced. The size of these multilayer structures is generally between 60 and 5000 nm, preferably between 80 and 300 nm.

The various morphologies of elastomer latex known to date can be used without difficulty within the scope of the present invention. In particular, it will be possible to use a latex of “soft-hard” morphology, where the first phase (or core) is an elastomer and the final “hard” phase (or outer layer) is a rigid thermoplastic. By rigid thermoplastic we mean a (co)polymer whose glass transition temperature or Tg is greater than or equal to 25° C.

These latices can be obtained in two stages, for example:
in a first stage, by emulsion polymerization, in an aqueous medium, in the presence of an initiator that generates free radicals and an emulsifying agent, of at least one monomer (called “soft”, i.e. a monomer leading to a polymer having a glass transition temperature below 25° C.) that is to constitute the elastomer phase, selected for example from monomers such as butadiene, substituted or unsubstituted, and alkyl or aralkyl acrylates in which the alkyl group has from 4 to 15 carbon atoms, then
in a second stage, also by emulsion polymerization in an aqueous medium, in the presence of the polymer from the first stage, of at least one monomer that is to constitute a “hard” phase compatible with the acrylic matrix whose impact resistance is to be improved. This monomer or these monomers (called “hard”, i.e. leading after polymerization to a polymer having a glass transition temperature greater than or equal to 25° C.) can be selected for example from the alkyl methacrylates in which the alkyl group contains from 1 to 4 carbon atoms, vinylaromatic monomers such as styrene and substituted styrenes, the monomers acrylonitrile and methacrylonitrile.

The “hard” phase can also be obtained starting from a mixture of the preceding hard monomers (as the major constituent) and ethylenically unsaturated comonomer(s), such as lower alkyl acrylate or (meth)acrylic acid.

The polymerization of the monomers not constituting the final “hard” phase must be carried out in the presence of crosslinking monomers and, optionally, grafting monomers. These crosslinking and grafting monomers are ethylenically unsaturated polyfunctional monomers that are copolymerizable with the monomers that do not constitute the final “hard” phase.

The copolymer constituting the final “hard” phase must therefore be formed in the presence of a crosslinking monomer. As well-known crosslinking monomers that can be used, we may mention the polyacrylates and polymethacrylates of polyols, such as the alkylene glycol diacrylates and dimethacrylates.

As grafting monomers that can be used if necessary, we may mention the allyl esters, such as allyl acrylate and methacrylate.

We may mention, as one embodiment of an impact modifying compound of “soft-hard” morphology, that prepared in the following way. An elastomer phase is prepared from a mixture comprising at least 50% of alkyl or aralkyl acrylate in which the alkyl group has from 4 to 15 carbon atoms, 0.05 to 5.0% of a crosslinking monomer, 0.05 to 5% of grafting monomers, 0 to 10% of a hydrophilic monomer (such as hydroxylated alkyl amides and esters of methacrylic acid, (meth)acrylic acid), the remainder being optionally constituted of other ethylenically unsaturated copolymerizable monomers (such as styrene). The final rigid thermoplastic phase, polymerized in the presence of the elastomer phase, can be obtained from a mixture of monomers comprising at least 50 wt. % of allkyl methacrylate, the elastomer phase and the thermoplastic phase having a minimum degree of chemical linkage of about 20%.

It is also possible to use a latex with “hard-soft-hard” morphology as the impact modifying compound to be incorporated in compositions (A), (B1) and optionally (C). In said structure, the first phase (heart or core), non-elastomeric, is polymerized from monomers that can constitute the acrylic matrix to be reinforced or the final “hard” phase as defined previously. The intermediate phase is elastomeric, and is obtained for example from so-called “soft” monomers as defined previously. Finally, the final phase is also formed from the monomers that can be used for the first phase.

In particular, a latex as described in U.S. Pat. No. 3,793,402 is suitable, which is formed:
(1) from a non-elastomeric core, constituted of a copolymer obtained from:
80 to 100% of at least one so-called “hard” monomer, such as an alkyl methacrylate (C₁-C₄ alkyl), styrene, (meth)acrylonitrile optionally combined (at a rate of 0 to 30%) with one or more ethylenically unsaturated comonomers, such as a lower alkyl (meth)acrylate (C₁-C₄ alkyl) and (meth)acrylic acid,
0 to 10 wt. % of a polyftnctional crosslinking monomer and
0 to 10 wt. % of a grafting monomer, such as those mentioned previously,
(2) from an elastomeric intermediate layer, formed in the presence of polymer (1), from
50 to 99.9% of substituted or unsubstituted butadiene monomer(s) and/or alkyl acrylate in which the alkyl group has from 1 to 8 carbon atoms,
0 to 49.9% of ethyleniically unsaturated comonomer(s) such as lower alkyl (meth)acrylates (C₁-C₄ alkyl), (meth)acrylic acid and styrene,
0 to 5 wt. % of a polyfunctional crosslinking monomer, and from
0.05 to 5 wt. % of a grafting monomer, such as those mentioned previously, and
(3) from a so-called “hard” or compatibilizing outer layer formed, in the presence of polymers (1) and (2), from “hard” monomers (C₁-C₄ alkyl methacrylate, styrene, (meth)acrylonitrile) optionally combined (at a rate of 0 to 30%) with ethylenically unsaturated comonomers such as a lower alkyl (meth)acrylate (C₁-C₄ alkyl). In particular, the various phases, core (1), intermediate layer (2) and outer layer (3) represent respectively, by weight, 10 to 40%, 20 to 60% and 10 to 70% of the total mass of the copolymer of the three-layer or (tliree-phase) composite.

Finally it is possible to incorporate, in compositions (A), (B1) and optionally (C), a product with soft/hard/soft/hard morphology as described in document EP-B-270865 which comprises (1) a central core based on a crosslinked elastomer intimately mixed with a methacrylic (co)polymer thermoplastic resin, (2) an optional first layer of said resin grafted on the central core, (3) a second layer of crosslinked elastomer grafted on said first layer or on said core and (4) a third layer of resin grafted on said second layer of crosslinked elastomer.

Other morphologies that can be used for compositions (A), (B1) and optionally (C) are those, more complex, described in patents U.S. Pat. No. 4,052,525 and FR-A-2446296.

The impact modifier incorporated in compositions (A), (B1) and optionally (C) is, advantageously, in the form of a polymeric substance having a multilayer structure. An impact modifying compound with “soft-hard” morphology is more particularly preferred. The impact modifiers that were assessed for the invention are as follows:
DURASTRENGTH D320 from the company ATOFINA;
IRH70 from the company Mitsubishi (soft/hard two-layer composite with a soft core of butadiene-butyl acrylate copolymer and hard skin of methyl homomethacrylate);
KM355 from the company Rhom & Haas (soft/hard two-layer composite with a soft core of butadiene-butyl acrylate copolymer and hard skin of methyl homomethacrylate).

It is not necessary for each of the compositions (A), (B1) and optionally (C) to contain the same type of impact modifier. For logistical reasons, however, it may be desirable for it to be the same impact modifier.

Regarding composition (A) of layer A and (C) of optional layer C, these comprise from 75 to 95% of a methacrylic (co)polymer containing mostly methyl methacrylate units and from 5 to 25% of an impact modifier.

Preferably, they comprise from 80 to 95% of a methacrylic (co)polymer containing mostly methyl methacrylate units and from 5 to 20% of an impact modifier.

According to a preferred variant, layer B1 is used as defined previously, which contains, in addition to the acrylic matrix, at least one impact modifier. A composition (B1) comprising from 30 to 50% of the acrylic matrix and from 50 to 70% of an impact modifier is preferred.

According to another variant, layer (B2) is used as defined previously. Reference should be made to U.S. Pat. No. 4,141,935 regarding the method of production of composition (B2).

In stage (1) of the method described in U.S. Pat. No. 4,141,935, it is preferable to employ an acrylate of an alkyl radical containing from 4 to 8 carbon atoms as monomer in stage (a). Regarding the crosslinking agents that can be added to the system of monomers, the following may be mentioned as examples of polyacrylic and polymethacrylic esters of polyols: butanediol di(meth)acrylate, trimethylolpropane tri(meth)acrylate, and as example of vinyl esters, vinyl acrylate.

Regarding stage (b), the following are used according to a preferred variant:
from 10 to 90% of at least one first acrylate of an alkyl radical containing from 1 to 4 carbon atoms, and
from 9 to 89.9% of at least one second acrylate of an alkyl radical containing from 4 to 8 carbon atoms, different from the first.

According to another preferred variant of this stage (b), whether or not used in combination with the preceding, from 0 to 5% of a crosslinking agent as defined previously for stage (a) is added to the system of monomers.

Regarding stage (c), it is preferable to use the following as the system of monomers:
from 5 to 40% of at least one acrylate of an alkyl radical containing from 4 to 8 carbon atoms, and
from 60 to 95% of at least one second acrylate of an alkyl radical containing from 1 to 4 carbon atoms., different from the first.

According to another preferred variant, whether or not used in combination with the preceding, from 0 to 5% of a crosslinking agent and from 0 to 1% of at least one grafting agent as defined previously for stage (a), as well as from 0 to 5% of a chain limiting agent selected from an alkylmercaptan having from 1 to 20 carbon atoms are added to the system of monomers.

Regarding stage (d), it is preferable to use the following as the system of monomers:
from 80 to 100% of at least one acrylate of an alkyl radical containing from 4 to 8 carbon atoms, and
from 0 to 20% of at least one second acrylate of an alkyl radical containing from 1 to 4 carbon atoms, different from the first.

According to another preferred variant of this same stage (d), whether or not used in combination with the preceding, from 0 to 5% of a crosslinking agent, from 0 to 1% of at least one grafting agent and from 0 to 5% of a chain limiting agent as defined previously for stage (c), and 0 to 5% of (meth)acrylic acid, are added to the system of monomers employed.

According to another preferred variant of stage (1) of the method of production of composition (B2), an alkylene diacrylate is used as crosslinking agent, and an allyl (meth)acrylate as grafting agent.

Stage (2) of preparation of composition (B2) comprises drying the aqueous emulsion obtained at the end of stage (1) by any means known by a person skilled in the art, notably by coagulation or atomization.

According to yet another variant, layer B3 is made starting from composition (B3) which comprises from 0 to 5 wt. % of at least one polymer A, and from 95 to 100 wt. % of at least one block copolymer B(-A)ₙ produced by controlled radical polymerization. The preparation of this block copolymer comprises:
polymerizing, at a temperature between 60 and 150° C., a mixture of monomers B₀ in the presence of an alkoxyamine of formula I(-T)ₙ up to a degree of conversion of 90%, then
removing a proportion or all of the unreacted monomers B₀, then
adding and polymerizing a monomer mixture A₀, then
removing all of the unreacted monomers and recovering the B(-A)ₙ copolymer.

Block B present in the block copolymer included in composition (B3) has a glass transition temperature (Tg) below 0° C., a weight-average molecular weight (M_{w}) between 40000 and 200000 g/mol and a polydispersity index (Ip) between 1.1 and 2.5 and preferably between 1.1 and 2.0. Said block B is obtained by the polymerization of a mixture of monomers B₀ comprising:
from 60 to 100 wt. % of at least one (meth)acrylic monomer b₁ of formula CH₂═CH—C(═O)—O—R₁ or CH₂═C(CH₃)—C(═O)—O—R₁ where R₁ denotes a hydrogen atom, a linear, cyclic or branched C₁-C₄₀ alkyl group optionally substituted by a halogen atom, a hydroxy, alkoxy, cyano, amino or epoxy group. It can be, for example, acrylic acid, methyl, ethyl, propyl, n-butyl, isobutyl, tert-butyl, 2-ethylhexyl, glycidyl acrylate, hydroxyalkyl acrylates, acrylonitrile. We may mention notably butyl, octyl, nonyl and 2-ethylhexyl acryl ate, acrylate(s) of polyethylene glycol or acrylonitrile, from 0 to 40 wt. % of at least one other monomer b₂ selected from monomers that are polymerizable by the radical route such as ethylenic, vinylaromatic and similar monomers. Examples are styrene, and substituted styrenes such as alpha-methylstyrene, monochlorostyrene, tert-butyl styrene.

It is preferable to use butyl acrylate and styrene as monomer(s) included in the constitution of block B.

Block A present in the block copolymer included in composition (B3) has a glass transition temperature (Tg) above 50° C. Block A is obtained by polymerization of a mixture of monomers A₀ comprising:
from 60 to 100 wt. % of at least one (meth)acrylic monomer a₁ of formula CH₂═CH—C(═O)—O—R₁ or CH₂═C(CH₃)—C(═O)—O—R₁ where R₁ denotes a hydrogen atom, a linear, cyclic or branched C₁-C₄₀ alkyl group optionally substituted by a halogen atom, a hydroxy, alkoxy, cyano, amino or epoxy group. It may be, for example, acrylic acid, methyl, ethyl, propyl, n-butyl, isobutyl, tert-butyl, 2-ethylhexyl, glycidyl acrylate, hydroxyalkyl acrylates, acrylonitrile. We may mention notably butyl, octyl, nonyl, 2-ethylhexyl acrylate, acrylates of polyethylene glycol or acrylonitrile.
from 0 to 40 wt. % of at least one monomer a₂ selected from the anhydrides such as maleic anhydride or vinylaromatic monomers such as styrene or its derivatives, in particular alpha-methylstyrene.

It is preferable to use a mixture of methyl methacrylate and butyl acrylate as monomer included in the constitution of block A.

The alkoxyamine used has the formula I(-T)ₙ in which I is an organic group corresponding to one of the following formula: 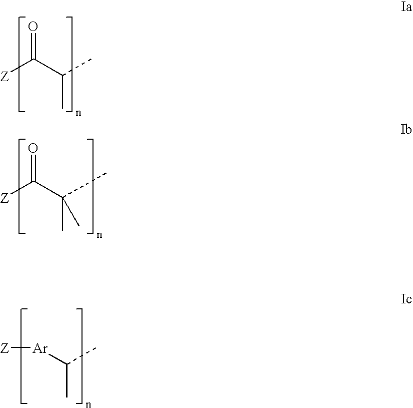
in which:
Ar denotes a substituted aromatic group,
Z is a polyfunctional organic radical with molar mass greater than or equal to 14, and
n is an integer greater than or equal to 2.

The following groups or radicals may be mentioned as possible meanings of Z:
a polyalkoxy group, especially dialkoxy, such as the radicals —OCH₂CH₂O—, —OCH₂CH₂CH₂O—, —O(CH₂)₄O—, —O(CH₂)₅O, —O(CH₂)₆O—, 1,3,5-tris(2-ethoxy)cyanuric acid.
a polyaminoamine such as the polyethylene-amines, 1,3,5-tris(2-ethylamino)cyanuric acid,
a polythioxy, phosphonate or polyphosphonate.

In the formula I(-T)ₙ, n represents the functionality of the alkoxyamine, i.e. the number of nitroxide radicals T that can be released by the alkoxyamine according to the mechanism:

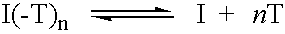

This reaction is activated by the temperature. In the presence of monomer(s), the activated alkoxyamine initiates a polymerization. The scheme given below illustrates the preparation of a copolymer A-B-A (or B(-A)₂) starting from an alkoxyamine for which n=2. The monomer mixture B₀ is first polymerized after activation of the alkoxyamine to give block B, then once block B is completed, the monomer mixture A₀ is polymerized next to give the two blocks A. B is a polymer block that is bound directly to I by a covalent bond, and is obtained by the polymerization of a monomer mixture B₀, A is a polymer block that is bound directly to block B by a covalent bond and is obtained by the polymerization of a monomer mixture A₀:

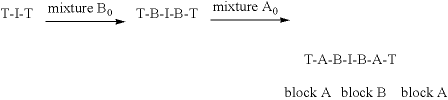

The principle of preparation of block copolymers remains valid for n>2.

T denotes a nitroxide of formula 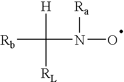
with Rₐ and R_{b} denoting identical or different alkyl groups having from 1 to 40 carbon atoms, optionally joined together so as to form a ring and optionally substituted by hydroxy, alkoxy or amino groups,
and R_{L} denoting a monovalent group of molar mass greater than 16 g/mol, preferably greater than 30 g/mol. Group R_{L} can for example have a molar mass between 40 and 450 g/mol. It is preferably a phosphorus-containing group of general formula: 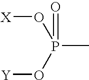
   in which X and Y, which may be identical or different, can be selected from the alkyl, cycloalkyl, alkoxyl, aryloxyl, aryl, aralkyloxyl, perfluoroalkyl, aralkyl radicals and can contain from 1 to 20 carbon atoms; X and/or Y can also be a halogen atom such as a chlorine, bromine or fluorine atom.

Advantageously, R_{L} is a phosphonate group of formula: 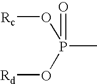
in which R_{c} and R_{d} are two identical or different alkyl groups, optionally joined so as to form a ring, containing from 1 to 40 carbon atoms, optionally substituted or unsubstituted.

Group R_{L} can also contain at least one aromatic ring such as the phenyl radical or the naphthyl radical, substituted for example by one or more alkyl radical(s) containing from 1 to 10 carbon atoms.

The nitroxide T preferably used conforms to the following formula:

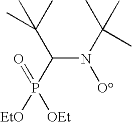

It can also be the following nitroxide:

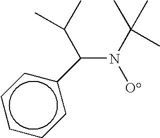

Preferably, the alkoxyamine is selected from the compounds conforming to one of the following( formulae: 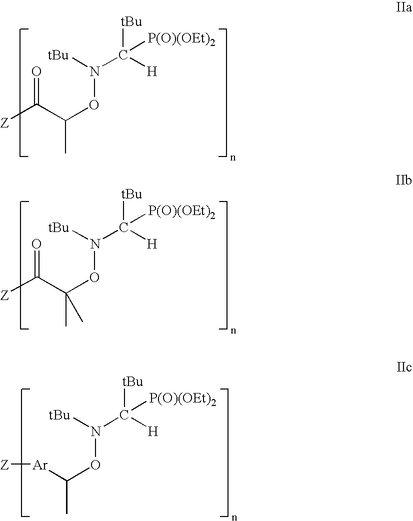
in which Z and Ar are as defined previously.

The following alkoxyamines are quite particularly preferred:

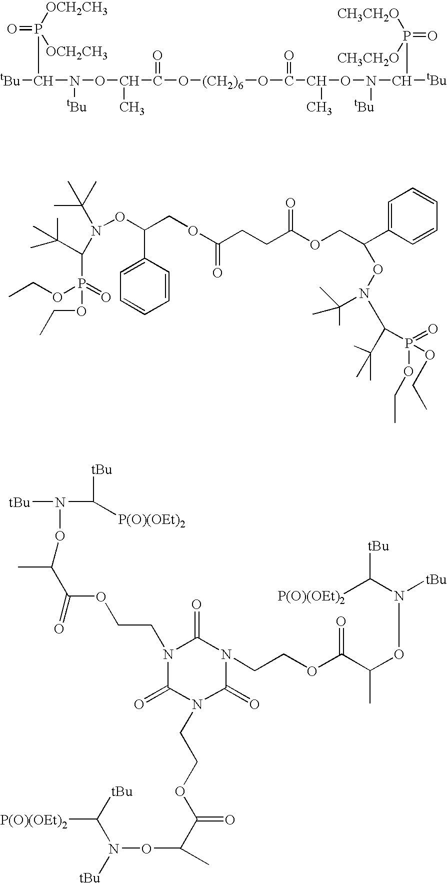

During formation of block A, there may be some loss of control of polymerization notably owing to the mechanism described below which corresponds to a reaction of transfer to the nitroxide:

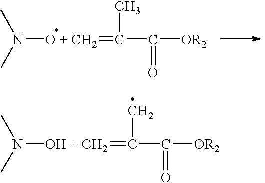

During formation of block A, loss of control may lead to the formation of polymer A. We thus find, in composition (B3), from 0 to 5 wt. % of polymer A per 95-100% of block copolymer DB(-A)ₙ.

Group I present in the block copolymer included in composition (B3) conforms to one of the general formulae Ia, Ib or Ic as defined previously. These compounds arose from thermal decomposition of the corresponding alkoxyamine of formula (IIa), (IIb) or (IIc). Radical Z included in general formulae Ia, Ib or Ic is joined to n functions of the acryl type in formula Ia, to n functions of the methacryl type in formula Ib and to n functions of the styryl type in Ic.

The weight-average molecular weight (M_{w}) of block copolymer B(-A)ₙ is between 80000 g/mol and 300000 g/mol with a polydispersity between 1.5 and 2.5.

Since monomers that arose from block B can be included in the composition of block A, to describe the copolymer completely it is necessary to state its total content of monomers from block B and the ratio between block B and block A. These two ratios are not necessarily equal. The copolymer B(-A)ₙ contains between 60% and 10% by weight of monomers from block B and preferably between 50 and 25%. The proportion of block B in the block copolymer is between 10 and 50%, preferably between 20 and 50%.

As examples of block copolymer B(-A)ₙ, we may mention the following three-block copolymers (in the case when n=2):
PMMA-b-n-butyl polyacrylate-b-PMMA
PMMA-b-poly(n-butyl acrylate-co-styrene)-b-PMMA
PMMA-b-poly(isobutyl acrylate-co-styrene)-b-PMMA
poly(methyl methacrylate-co-n-butyl acrylate)-b-poly(n-butyl acrylate-co-styrene)-b-poly(methyl methacrylate-co-n-butyl acrylate).

Regarding the multilayer acrylic film, this is manufactured by coextrusion according to a technique that is usual in the field of thermoplastics. The compositions intended for the manufacture of layers A, B₁₋₃ and if necessary C of the films according to the invention are generally in the form of granules. According to this technique, the material corresponding to the various layers (introduced in the form of granules and melted) is forced through slot dies arranged very close together. The multilayer film is formed by combining the molten materials, and is then cooled by being passed over rollers at controlled temperature. By adjusting the speeds of rollers arranged in the longitudinal and/or transverse direction, it is possible to cause stretching in the longitudinal direction and/or in the transverse direction, which, together with the geometry used for the lies, makes it possible to control the thicknesses of the different layers.

The thermoplastic compositions described previously, used for making the various layers of the multilayer film (A, B₁₋₃, C), can each contain usual additives, such as lubricant, UV stabilizer, antistatic agent, colouring matter, antioxidant, and mineral filler in an amount from 0 to 5 wt. % relative to the composition.

The present invention also relates to the use of the multilayer acrylic film as defined previously for the technique of in-mould decoration of articles made of thermoplastic resin, and more particularly for the technique of moulding with simultaneous film insertion (FIM).

The film according to the invention can be used for coating a substrate. Regarding the substrate that can be coated by the multilayer acrylic film of the invention, this can be a substrate made of a thermoplastic resin. The thermoplastic resin can be:
a polyolefin such as polyethylene (e.g. HDPE, PE metallocene, LDPE, LDLPE), polypropylene, or an ethylene-propylene copolymer;
a chlorinated resin such as PVC, plasticized PVC, chlorinated polyethylene;
polycarbonate;
an acrylonitrile-butadiene-styrene (ABS) resin;
a polymer or copolymer containing styrene such as polystyrene, SAN;
a saturated polyester (PET, PBT, etc.);
a polymer of ethylene and vinyl acetate (EVA) or of ethylene and alkyl acrylate, optionally in the presence of a termonomer for example maleic anhydride;
a polyamide or copolyamide;
a polyesteramide;
a copolymer of ethylene and vinyl alcohol (EVOH);
a polyurethane.

Mixing several thermoplastic resins together falls within the scope of the present invention. For example, it could be a blend of two polyolefins, of polycarbonate and of ABS.

The substrate can also be made of a thermosetting resin (thermoset). It may be for example:
phenolic resin;
epoxy resin:
melamine resin;
melamine-formaldehyde resin;
melamine-phenolic resin;
urea-formaldehyde resin.

A list of resins that may be considered is given in Ullmann's Encyclopaedia of Industrial Chemistry, 5th edition, Vol. A20, “Plastics, general survey”, p. 549-552.

This substrate can also be of wood, compreg, cellulosic material, steel, aluminium, wood coated with a layer of melamine, melamine-formaldehyde or melamine-phenolic resin. Preferably, the acrylic film is used for coating a thermoplastic resin, for example by the FIM technique.

The acrylic film of the invention will coat the substrate, giving a multilayer structure of the type:
substrate/layer C/layer B1/layer A
substrate/layer C/layer B2/layer A
substrate/layer B2/layer A
substrate/layer C/layer B3/layer A
substrate/layer B3/layer A

An adhesive can be used optionally for ensuring adhesion of the film to the substrate. The adhesive is then arranged between the substrate and the acrylic film. The following structures are then obtained:
substrate/ adhesive/layer C/layer B1/layer A
substrate/adhesive/layer C/layer B2/layer A
substrate/adhesive/layer B2/layer A
substrate/adhesive/layer C/layer B3/layer A
substrate/adhesive/layer B3/layer A

The adhesive can be a glue or a polymeric film that can ensure adhesion between the substrate and the layer of the acrylic film in contact with the substrate.

### EXAMPLES

The following example is given purely to illustrate the invention, and is not to be interpreted in any way as limiting its scope.

The methods of assessment of the multilayer film are as follows:
degree of transparency (or Haze): ASTM D1003
elongation at break and elastic modulus: ASTM D882
surface hardness measured by retention of gloss after the washing test according to the method PSA D245359/B published by the company Peugeot-Citroën
shiny appearance (or gloss): ASTM D523
   Layers A and C:

A copolymer is used in containing 99.4% of methyl methacrylate units and 0.6% of ethyl acrylate which is available commercially in the form of granules (Altuglas® V825 of the company ATOGLAS).

The impact modifier used is a SOFT/HARD two-layer system in which the soft core is a copolymer of butadiene and butyl acrylate, and the hard skin is a methyl methacrylate homopolymer which is available commercially in the form of powder (IRH70® from the company Mitsubishi).

The impact modifier and the granules of acrylic matrix are mixed together, so as to have a content of impact modifier of 20 wt. %. Mixing is carried out at about 200° C. in a twin-screw extruder, resulting in several extruded rods which are then cut into granules.

Layer B:

The acrylic matrix used is a copolymer containing 75 wt. % of methyl methacrylate units and 25% of ethyl acrylate, in the form of granules.

The impact modifier used is a SOFT/HARD two-layer system in which the soft core is a copolymer of butadiene and butyl acrylate, and the hard skin is a methyl methacrylate homopolymer which is available commercially in the form of powder (KM355® from the company Rhom & Haas).

The impact modifier and the granules of acrylic matrix are mixed together, so as to have a content of impact modifier of 60 wt. %. Mixing is carried out at about 200° C. in a twin-screw extruder, resulting in several extruded rods which are then cut into granules.

The granules intended for layer B are introduced into a single-screw extruder with diameter of 30 mm and the granules intended for layers A and C are introduced into 2 single-screw extruders with diameter of 20 mm. These 3 extruders feed a coextrusion die of annular shape with diameter of 50 mm, heated to a temperature of 240° C. Adhesion between the 3 layers is therefore achieved in the molten state.

The 3-layer film in the shape of a cylinder is formed continuously, pulled upwards by a suitable device and inflated by air introduced via the inner part of the annular die. The sleeve of film thus formed is also cooled externally, by jets of air from a ring, concentric with the annular die.

The sleeve of film is cut along a generating line, and the three-layer film is wound onto a reel.

The thickness of the 3 layers is measured by optical microscopy:
thickness of layer A: 5 μm
thickness of layer B: 80 μm
thickness of layer C: 5 μm.

Using the methods of assessment noted above, the following results are obtained:
Haze=2.5%.
Elongation at break=80%
Elastic modulus=980 MPa
Hardness=80%
Gloss (measured at 20°)=81

1. Multilayer acrylic film having a thickness between 40 and 300 μm, comprising in this order:
a layer A made from a thermoplastic acrylic composition (A) comprising from 75 to 95% of a methacrylic (co)polymer containing mostly methyl methacrylate units and from 5 to 25% of an impact modifier;
a layer B1 made from a composition (B1) comprising from 10 to 50% of a methacrylic (co)polymer containing mostly methyl methacrylate units and from 50 to 90% of an impact modifying compound;
a layer C made from a thermoplastic acrylic composition (A) comprising from 75 to 95% of a methacrylic (co)polymer containing mostly methyl methacrylate units and from 5 to 25% of an impact modifier;
the layers A, B1 and C being joined together in their respective contact zones and the ratio of the thickness of layer B1 to the total thickness of the multilayer film being between 85 and 99%, preferably between 88 and 95%, and more preferably between 88 and 92%.

2. Film according to claim 1, characterized in that the ratio of the thickness of layer B1 to the total thickness of the multilayer film is between 88 and 95%.

3. Film according to claim 1, characterized in that composition (B1) comprises from 30 to 50% of a methacrylic (co)polymer, and from 50 to 70% of an impact modifier.

4. Film according to claim 1, characterized in that the impact modifier comprises a polymeric substance having a multilayer structure.

5. Film according to claim 4, characterized in that the impact modifier has a “soft-hard” morphology.

6. (canceled)

7. Multilayer acrylic film having a thickness between 40 and 300 μm, comprising in this order:
a layer A made from a thermoplastic acrylic composition (A) comprising from 75 to 95% of a methacrylic (co)polymer containing mostly methyl methacrylate units and fi-on 5 to 25% of an impact modifier:
a layer B2 made from a composition (B2) that can be obtained by the method comprising:
1) preparation by sequential polymerization in aqueous emulsion:
a) of a first copolymer, by reaction of a system of monomers comprising:
from 75 to 99.8% of at least one acrylate of an alkyl radical comprising from 1 to 8 carbon atoms, and
from 0.1 to 5% of a crosslinking agent selected from the polyacrylic and polymethacrylic esters of polyols, the di- or trivinyl benzenes or the vinyl esters, and
from 0.1 to 20% of at least one grafting agent selected from the allylic, methallylic or crotonic esters of an α,β-unsaturated monocarboxylic or dicarboxylic acid; then
b) of a second copolymer, in the presence of the aqueous system resulting from stage a), by reaction of a system of monomers comprising:
from 10 to 90% of at least one first acrylate of an alkyl radical containing from 1 to 8 carbon atoms, and
from 9 to 89.9% of at least one second acrylate of an alkyl radical containing from 1 to 8 carbon atoms, different from the first one, and
0.1 to 1% of at least one crafting agent selected from the allylic, methallylic or crotonic esters of an α,β-unsaturated monocarboxylic or dicarboxylic acid; then
c) of a third copolymer, in the presence of the aqueous system resulting from stage b), by reaction of a system of monomers comprising:
from 5 to 40% of at least one acrylate of an alkyl radical containing from 1 to 8 carbon atoms, and
from 60 to 95% of at least one second acrylate of an alkyl radical containing from 1 to 8 carbon atoms, different from the first one; then
d) of a fourth polymer, in the presence of the aqueous system resulting from stage c), by reaction of a system of monomers comprising:
from 80 to 100% of at least one acrylate of an alkyl radical containing from 1 to 8 carbon atoms, and
from 0 to 20% of at least one second acrylate of an alkyl radical containing from 1 to 8 carbon atoms, different from the first one;
it being stipulated that:
the weight of the copolymer obtained in stage a) represents from 10 to 75%, and
the total weight of the copolymers introduced in stages b), c) and d) represents from 25 to 90%, relative to the total weight of the composition comprising the 4 copolymers obtained after stage d); then
2) drying of the aqueous emulsion thus obtained; then
3) optionally, granulation of the product thus dried;
optionally a layer C made from a thermoplastic acrylic composition (C) comprising from 75 to 95% of a methacrylic (co)polymer containing mostly methyl methacrylate units and from 5 to 25% of an impact modifier;
the layers A, B2 and optionally C being joined together in their respective contact zones.

8. Film according to claim 7, characterized in that the ratio of the thickness of layer B2 to the total thickness of the multilayer film is between 85 and 99%,.

9. Multilayer acrylic film having a thickness between 40 and 300 μm, comprising in this order:
a layer A made from a thermoplastic acrylic composition (A) comprising from 75 to 95% of a methiacrylic (co)polymer containing mostly methyl methacrylate units and from 5 to 25% of an impact modifier:
a layer B3 made from a composition (B3) comprising from 0 to 5 wt % of at least one polymer A and from 95 to 100 wt % of at least one block copolymer of formula B(-A)ₙ composed of a block B and n blocks A obtained by radical polymerization controlled by means of an alkoxyamine of formula I(-T)ₙ in which I denotes a multivalent group, T denotes a nitroxide and n denotes an integer greater than or equal to 2;
optionally a layer C made from a thermoplastic acrylic composition (A) comprising from 75 to 95% of a methacrylic (co)polyiner containing mostly methyl methacrylate units and from 5 to 25% of an impact modifier;
layers A, B3 and optionally C being joined together in their respective contact zones.

10. Film according to claim 9, characterized in that the ratio of the thickness of layer B3 to the total thickness of the multilayer film is between 85 and 99%.

11. Film according to claim 10, characterized in that block B is obtained by polymerization of a monomer mixture B₀ comprising:
from 60 to 100 wt % of at least one (meth)acrylic monomer b₁ of fornula CH₂═CH—C(═O)—O—R₁ or CH₂═C(CH₃)—C(═O)—O—R₁ where R₁ denotes a hydrogen atom, a linear, cyclic or branched C₁-C₄₀ alkyl group optionally substituted by a halogen atom, a hydroxy, alkoxy, cyano, amino or epoxy group;
from 0 to 40 wt % of at least one other monomer b₂ selected from monomers that are polymerizable by the radical route such as ethylenic, vinylaromatic and similar monomers.

12. Film according to claim 9, characterized in that block B has a glass transition temperature below 0° C. a weight-average molecular weight between 40000 and 200000 g/mol and an index of polymolecularity between 1.1 and 2.5,

13. Film according to claim 9, characterized in that block A is obtained by the polymerization of a monomer mixture A₀ comprising:
from 60 to 100 wt % of at least one (meth)acrylic monomer a₁ of formula CH₂═CH—C(═O)—O—R₁ or CH₂═C(CH₃)—C(═O)—O—R₁ where R₁ denotes a hydrogen atom, a lineal-, cyclic or branched C₁-C₄₀ alkyl group optionally substituted by a halogen atom, a hydroxy, alkoxy, cyano, amino or epoxy group;
from 0 to 40 wt % of at least one monomer a₂ selected from the anhydrides such as maleic anhydride or vinylaromatic monomers such as styrene or its derivatives, in particular alpha-methylstyrene.

14. Film according to claim 9, characterized in that block A has a glass transition temperature above 50° C.

15. Film according to claim 9, characterized in that I is an organic group conforming to one of the following formula: 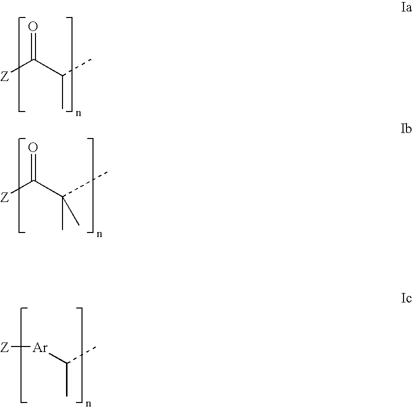
in which:
Ar denotes a substituted aromatic group,
Z is a polyfunctional organic radical with molar mass greater than or equal to 14, and
n is an integer greater than or equal to 2.

16. Film according to claim 9, characterized in that the alkoxyamine is selected from the compounds conforming to one of the following formula: 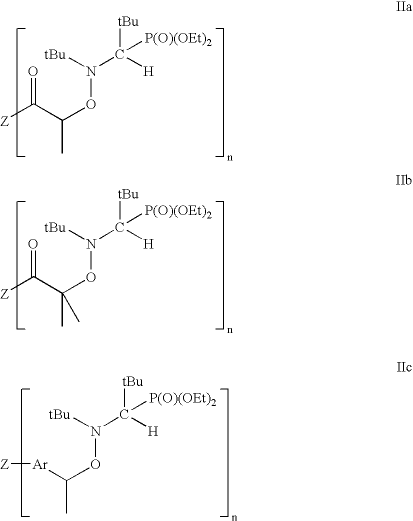
in which:
Ar denotes a substituted aromatic group,
Z is a polyfunctional organic radical with molar mass greater than or equal to 14, and
n is an integer greater than or equal to 2.

17. Film according to claim 9, in which T denotes a nitroxide of formula 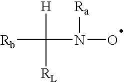
with Rₐ and R_{b} denoting identical or different alkyl groups having from 1 to 40 carbon atoms, optionally joined together so as to form a ring and optionally substituted by hydroxy, alkoxy or amino groups,
and R_{L} denoting a monovalent group of molar mass greater than 16 g/mol,

18. Film according to claim 17, characterized in that the nitroxide T conforms to the formula:

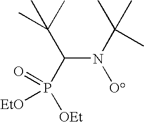

19. Film according to claim 1, characterized in that the methacrylic (co)polymer used for the manufacture of layers (A) and optionally (C), as well as for composition (B1) of layer B, comprises from 51 to 100% of methyl methacrylate units and from 0 to 49% of ethylenically unsaturated comonomer units copolymerizable with methyl methacrylate.

20. Film according to claim 1, characterized in that the same methacrylic (co)polymer is used for layers A and C.

21. Film according to claim 1, characterized in that the acrylic copolymer comprises from 80 to 99 wt % of methyl methacrylate units and from 1 to 20% of (meth)acrylic acid or of the corresponding ester with an alkyl radical containing from 1 to 4 carbon atoms.

22. An in-mould decorated article comprising a thermoplastic resin and the film of claim 1.

23. (canceled)

24. A coated substrate comprising a substrate coated with the film of claim 1.

25. The coated substrate according to claim 24, characterized in that the substrate is a thermoplastic resin.

26. The coated substrate according to claim 24, characterized in that the substrate is a thermosetting resin.

27. The coated substrate according to claim 24, characterized in that the substrate is of wood, compreg, a cellulosic material, steel, aluminium, wood coated with a layer of melamine, melamine-formaldehyde or melamine-phenolic resin.

28. The coated substrate according to claim 24 characterized in that an adhesive is arranged between the substrate and the film.

29. The multiplayer acrylic film of claim 1, having a thickness between 70 and 100 μm.

30. The multiplayer acrylic film of claim 7, having a thickness between 70 and 100 μm.

31. The multiplayer acrylic film of claim 9, having a thickness between 70 and 100 μm.

32. The multiplayer film of claim 1, wherein the ration of the thickness of layer B1 to the total thickness of the multiplayer film is between 88 and 92%.

33. Film according to claim 12, characterized in that block B has an index of polymolecularity between 1.1 and 2.0.

34. Film according to claim 9 wherein R_{L} denotes a monovalent group of molar mass greater than 30 g/mol.
